(19) United States
(12) Patent Application Publication
(10) Pub. No.: US 2013/0318353 A1
(43) Pub. Date: Nov. 28, 2013

(54) Method for Creating and Installing a Digital Certificate

(71) Applicant: Christopher Skarda, Pleasant Grove, UT (US)

(72) Inventor: Christopher Skarda, Pleasant Grove, UT (US)

(73) Assignee: DIGICERT, INC., Lindon, UT (US)

(21) Appl. No.: 13/480,312

(22) Filed: May 24, 2012

(51) Int. Cl. H04L 9/28

(52) U.S. Cl. 713/175

(57) ABSTRACT

The invention comprises a method of creating a certificate based on the contents of another certificate. The certificate is then automatically installed and configured on the server where it will be used. A further enhancement automatically requests and installs the certificate prior to an existing certificate's expiration.

### BACKGROUND

Digital certificates are used to convey trust in a message or object secured by the digital certificate. For example, SSL digital certificates are used to secure online transactions by preventing a bad actor from reading the communication between a browser and server. Code signing certificates are used to verify that the signed object has not been modified since signing. Code signing certificates provide a reliable indication of the signed object's source and prevent bad actors from re-packaging safe objects with harmful malware.

Digital certificates are issued by a certification authority (CA). CAs are responsible for verifying the identity of the certificate applicant and making sure the applicant has complied with any requirements applicable to the community that will rely on the digital certificate. A CA is a digital certificate provider that a community trusts to apply and enforce its certificate issuance requirements. The CA usually has a trusted root certificate. When a member of the applicable community wants to check a certificate for trust, software used by the member will check the certificate to see if it was signed by a trusted CA.

Some communities rely on the specific contents of a certificate to establish trust. If one field in the certificate is incorrect, the certificate may become untrusted or have a limited usefulness. In addition, some certificates include identifiers that build trust over time. If these identifiers are modified, the certificate may lose any established trust.

Many certificates are also difficult to properly installed and configure, especially where multiple certificates are necessary to establish trust. A mis-installed or mis-configured certificate will cause the certificate to function improperly and not convey the appropriate trust. Fixing installation and configuration issues results in a significant waste of company resources.

Therefore, there is a need for an improvement in both certificate issuance and installation practices. There is a need for a simple way to ensure that a certificate is issued correctly and, once issued, that the certificate is properly configured on the server or device where it will be used.

### SUMMARY OF THE INVENTION

The current invention discloses a method of creating and installing a digital certificate. A CA creates a new certificate using the contents of the existing digital certificate. The new certificate may contain slight modifications or removed fields. Using the existing certificate's contents to create the new certificate eliminates the possibility of mistyped or mis-entered identifier information.

Once the certificate is created, certificate software installs the certificate to the proper location on the certificate applicant's server. The certificate software uses an installation code to identify the proper location on the server. The certificate software may install a configuration file that configures the server to use the certificate. This may include updating existing configuration files to redirect any points to an existing certificate to the new certificate.

### BRIEF DESCRIPTION OF THE FIGURES

FIG. 1 is a flowchart of the process used in creating and installing a new digital certificate.

FIG. 2 is a diagram of the how the components of the invention interact during the certificate request and creation process.

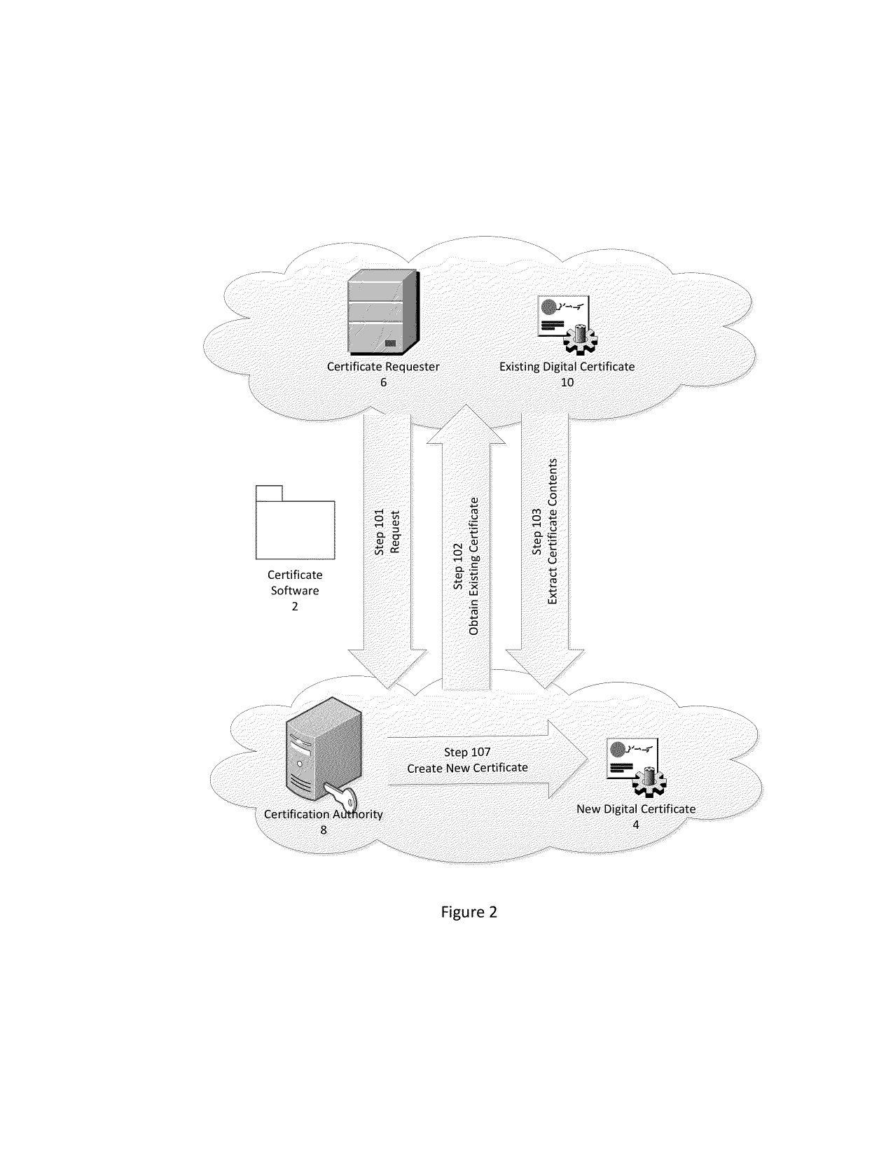

FIG. 3 is a diagram of how the components of the invention interact during the certificate installation process.

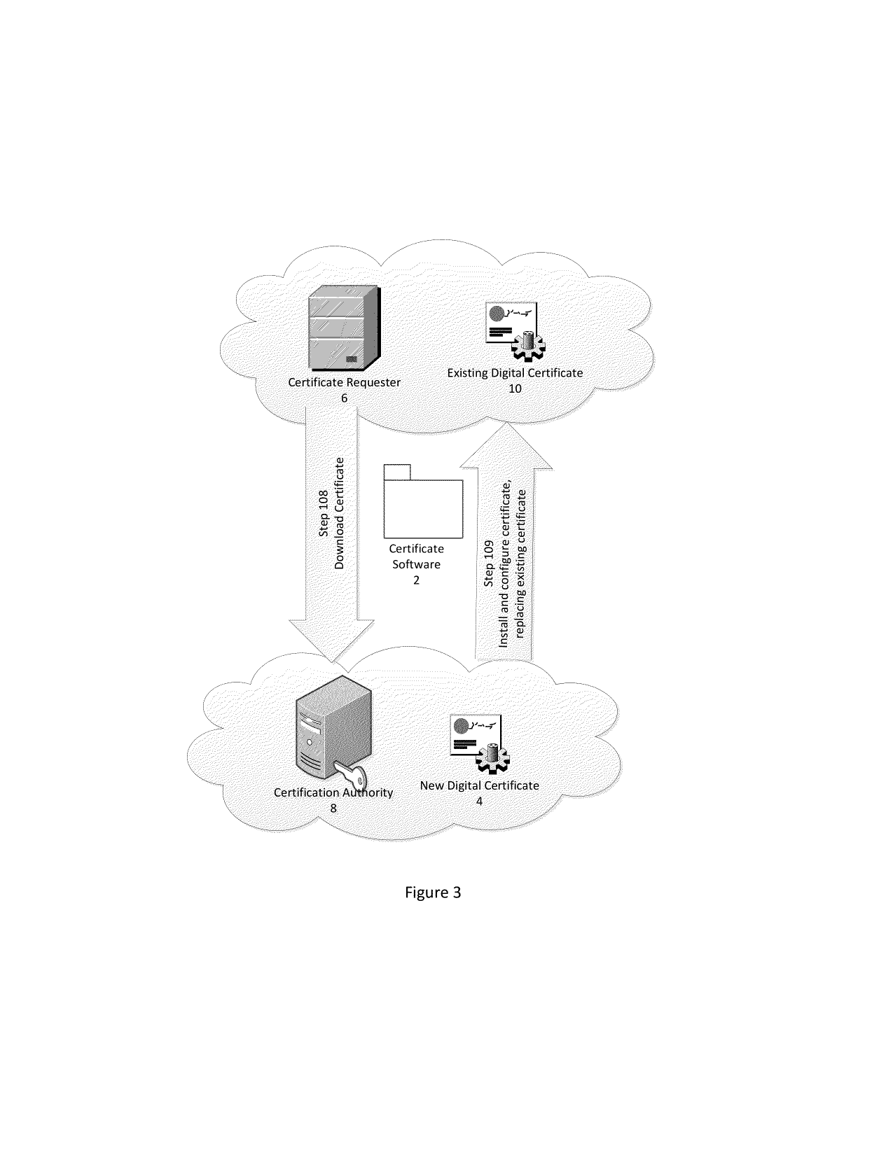

FIG. 4 is a flowchart of an alternate embodiment of the invention where a certificate is requested and issued automatically.

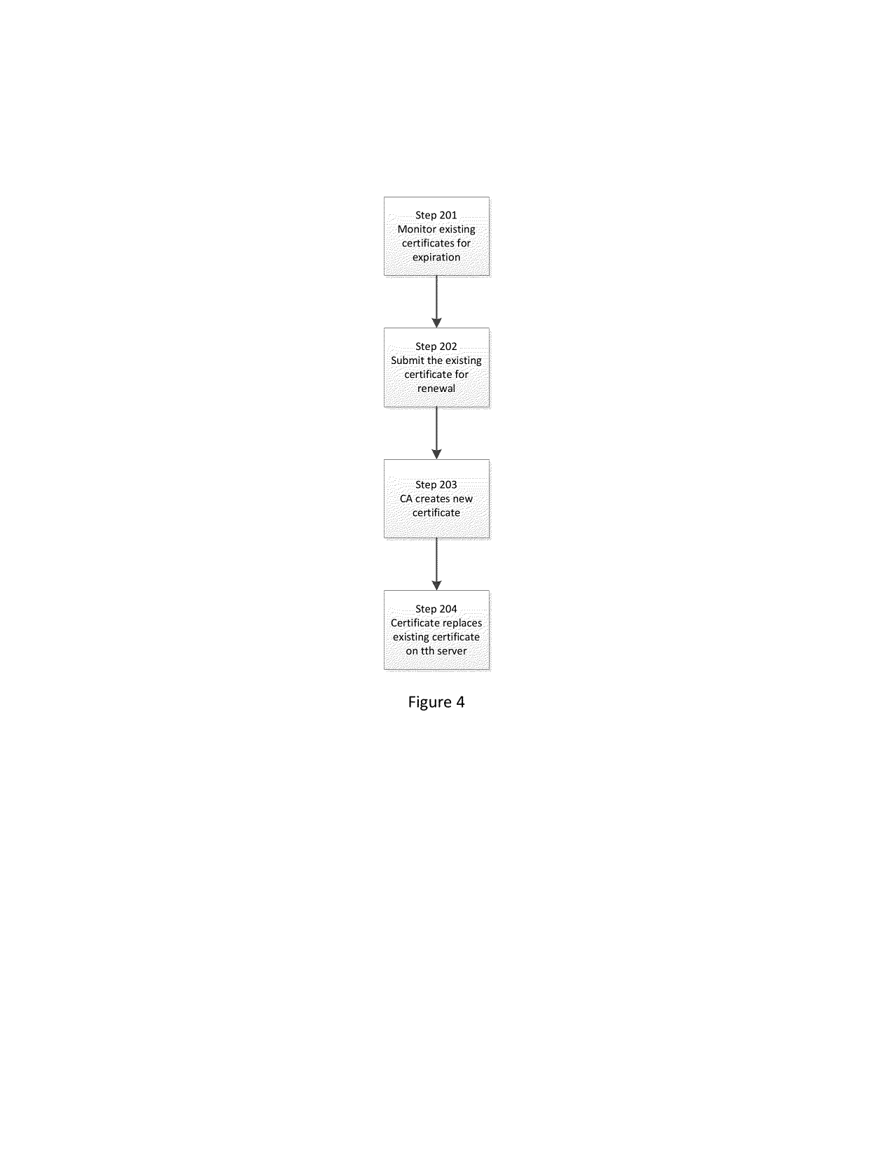

FIG. 5 is a diagram showing how the components interact when requesting and issuing a certificate automatically.

### DESCRIPTION OF INVENTION

The invention teaches a method of generating a digital certificate (certificate) and installing the certificate on a server. As used herein, certificate software is any computer program used to accomplish the tasks described herein. Certificate software includes a website plugin, an online account controlled by a software provider, and stand-alone software. A certification authority (CA) is any entity or device which provides digital certificate issuance services. A certificate requester is an individual or device that requests the issuance of a digital certificate from a CA. The certificate applicant is not necessarily the entity named in the issued digital certificate.

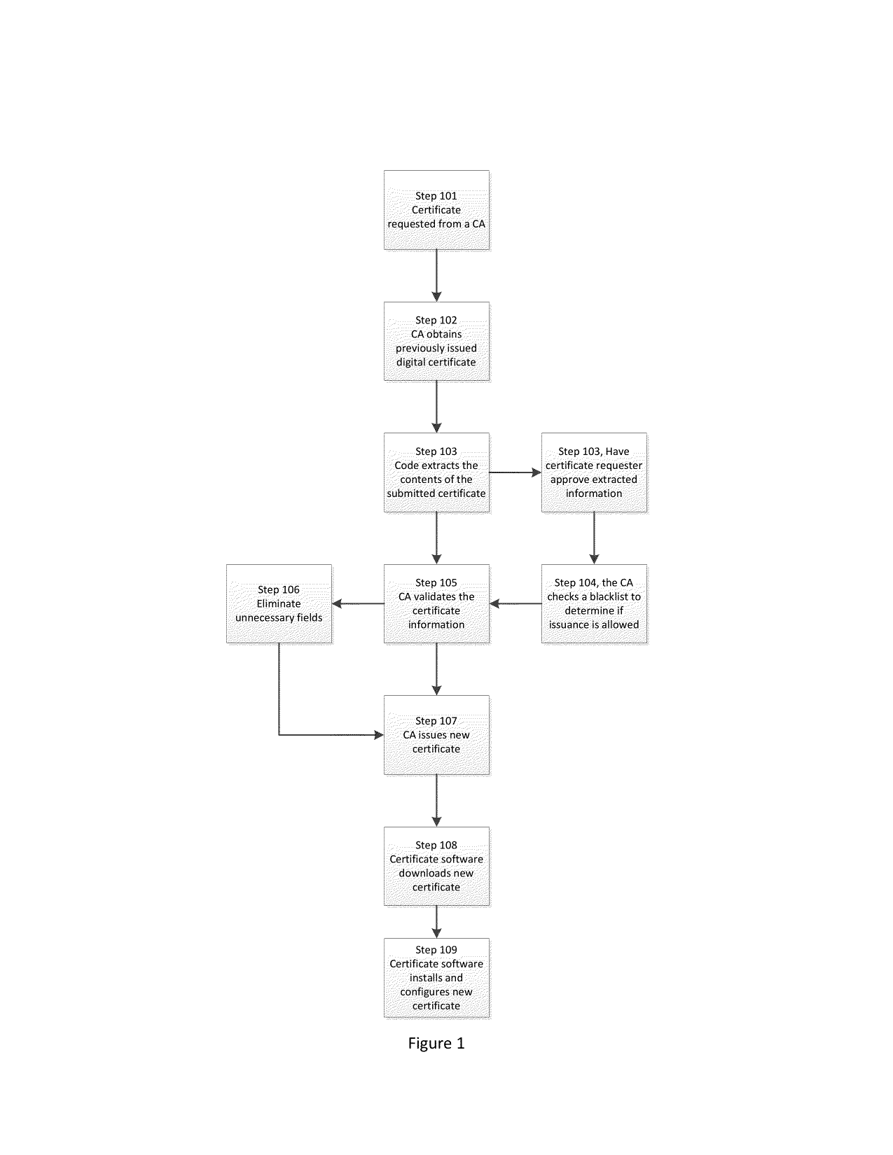

In Step 101 of FIG. 1, a certificate requester 6 or the certificate software 2 requests a new or renewed digital certificate 4 from a certification authority (CA) 8. This may include a CSR generated from an existing or new key pair. The certificate software may create the CSR.

In Steps 102, which may be accomplished as part of the certificate request, the CA 8 obtains a previously issued digital certificate 10. The CA 2 may obtain the previously issued digital certificate 10 by scanning the certificate requester's 6 server for a digital certificate, by having the certificate requester provide a copy of the previously issued digital certificate during the order process, by having the certificate requester specify the location where their certificate is located (such as the domain name or IP address where the certificate is accessible, by having the CA scan relevant ports to determine where the digital certificate is available, by looking up the previously issued certificate in a database, or through other means. For SSL digital certificates, the certificate requester ideally enters a domain name during the application process. The CA checks this domain and, if a certificate is found, downloads the previously issued digital certificate from provided domain name.

In Step 102, the CA 8 extracts the previously issued digital certificate's 10 information. The certificate software 2 or the CA 8 may extract this information, and the information may include the existing pubic key. The certificate software 2 may display the information extracted from the existing digital certificate 10 to the certificate requester (or a person operating the certificate requester) and require confirmation of the extracted contents before sending the information to the CA.

In Step 104, the CA 8 may perform a blacklist check on the domain name where the existing digital certificate was installed or on the entity name included in the digital certificate. A blacklist check might comprise the certificate software determine whether the domain name or entity name is listed in a database of high risk domain names and entities. If the domain name or entity name is in the database, the certificate software may alert the CA, require that special approval be given from either the certificate requester's organization or the CA before generating the new digital certificate, or limit the automated issuance of the new digital certificate.

In Step 105, the CA 8 generates a new digital certificate 4 based on the extracted information. This occurs after any required verification of the certificate's information is complete. The new digital certificate's fields should match the information extracted from the existing digital certificate; however, the CA may make minor changes. If a new private key was generated as part of the certificate request, the new public key will be included in the new certificate instead of the public key associated with the existing certificate. Generally, any identifier in the subject field of the existing certificate should identically match the identifiers in the new certificate.

In Step 106, the CA 8 may wish to identify fields that are not necessary and eliminate them in the new certificate's profile. For example, the OU field in most certificates contains CA-specific information. The issuing CA would generally not want to include the old CA's information if the existing certificate was issued by a competitor. The CA may remove these fields or have the certificate software identify and remove unnecessary information. The information may be removed any time during the certificate application and creation process, including during the certificate extraction process.

Creating the new certificate using the old certificate's contents ensures that errors are not introduced by the submission of the private key and eliminates the need for the customer to copy and paste a CSR during the digital certificate application process.

In Step 108, the certificate software 2 connects to the location where the new digital certificate 4 is stored. The certificate software 2 retrieves the new digital certificate 4 and installs it on the certificate requester server 6. The certificate software 2 may install the new digital certificate to a set location on the server. The certificate software 2 may also evaluate the server's configuration to determine where digital certificates are installed and use that location once determined. Alternatively, the certificate software 2 determines where to install the new certificate 4 using an installation code generated by software with access to the certificate requester's server (typically the certificate software). The installation code correlates to a defined location on the certificate requester's server. This installation code may be as simple as a location URI of where the existing certificate 10 is located. The certificate software interprets this code and saves the installed certificate to the location. The installation code may also be a string or a file. If a file is used, the installation code may include configuration instructions.

The certificate software 2 may automatically configure the server to use the new digital certificate by looking at the server's attributes associated with an existing digital certificate and modifying or reusing these attributes with the new digital certificate. Looking at the security attributes of the old or an existing certificate avoids unwittingly reducing the server's security and keeps all permissions related to the new digital certificate the same as other certificates.

The certificate software may obtain configuration instructions by scanning the certificate requester's systems to find all references to the old digital certificate. During the certificate installation process, the certificate software automatically updates these references with the new certificate's information.

The installation code may also contain instructions for the certificate software to obtain additional files, such as intermediate or root certificates. If this information is contained in the installation code, the certificate software downloads and installs the relevant files.

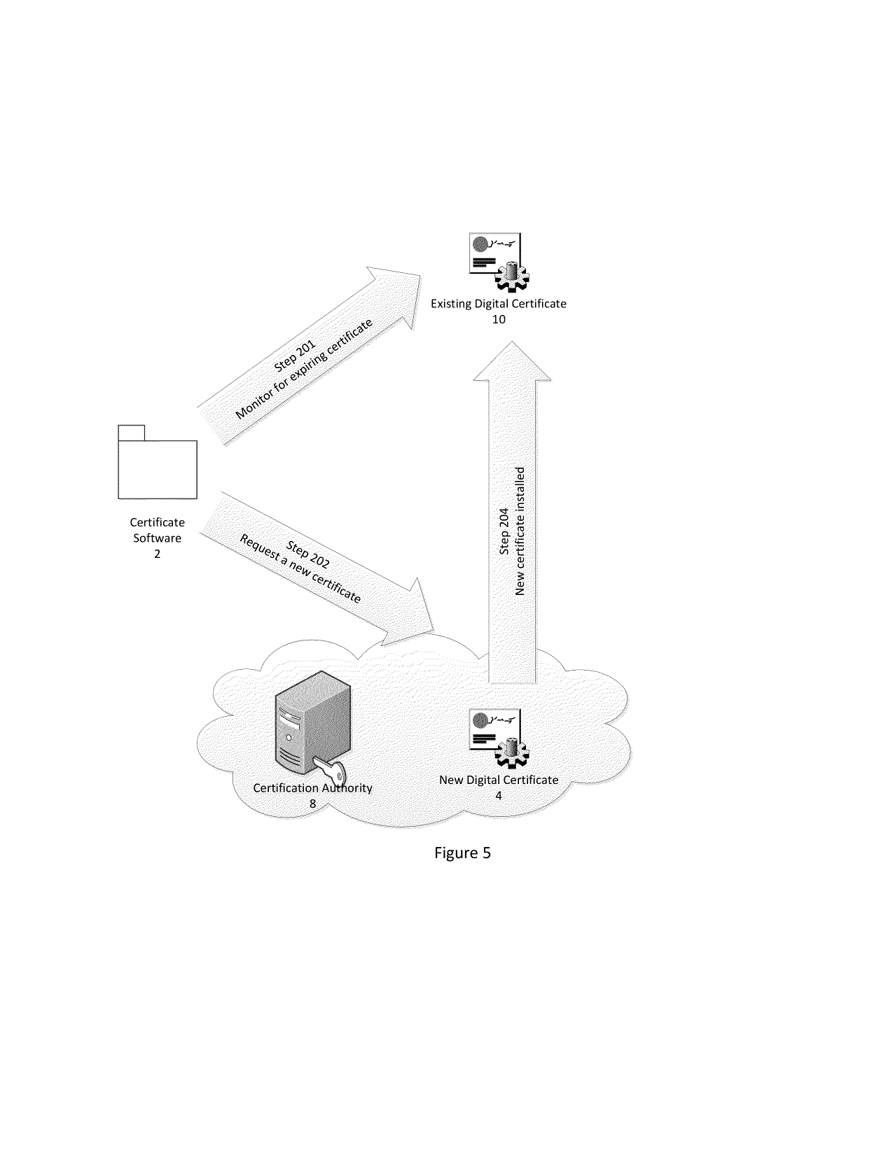

An alternate embodiment, shown in FIG. 5, has the certificate software 2 monitor the certificate requester's list of certificates for expiration. This can be done using a database maintained by the CA or the certificate software or by having certificate software periodically scan the certificate requester's systems or websites for digital certificates nearing the end of the digital certificate's lifecycle.

In step 202, if an existing certificate is within a set timeframe for expiration, the certificate software 2 either reminds the certificate requester to order a new certificate or automatically requests a new digital certificate from the CA 8. The certificate software 2 automatically submits the old digital certificate (or its contents) as part of the new digital certificate request. The certificate software may automatically bill the certificate requester's account when the new digital certificate is requested or generated. Once payment is received, the certificate is created and installed on the server, replacing the expiring certificate. This entire process is automatic to ensure that the certificate is created and installed hand-free.

What is claimed is:

1. A method of creating a digital certificate comprising:
Obtaining an existing digital certificate;
Extracting the contents of the existing digital certificate; and
Creating a new digital certificate based on the extracted contents.

2. A method according to claim 1, where the existing digital certificate is obtained by certificate software.

3. A method according to claim 1, where the existing digital certificate is obtained by a CA from a website where the digital certificate is used.

4. A method according to claim 1, where the existing digital certificate is obtained when the request of a new digital certificate is submitted to a CA.

5. A method according to claim 1, where the extraction occurs using certificate software.

6. A method according to claim 1, further comprising having an entity associated with the certificate approve the extracted information.

7. A method according to claim 1, where the contents of at least one subject field in the new digital certificate is matched to a corresponding Subject fields in the existing digital certificate.

8. A method according to claim 1, where the contents of at least one subject field in the new digital certificate are not the same as those found in the existing digital certificate.

9. A method of obtaining a digital certificate comprising:
Requesting a new digital certificate;
Submitting information about an existing digital certificate; and
Downloading a new digital certificate that was created based on the contents of the existing digital certificate.

10. A method according to claim 9 where the request for a new digital certificate includes automatically creating and submitting a CSR.

11. A method according to claim 10 where the CSR is based on a newly generated key pair.

12. A method according to claim 9 where the request occurs automatically within a set threshold of the certificate's expiration date.

13. A method of installing a digital certificate comprising:
Determining the location of an existing certificate,
Installing a new digital certificate to the location of the existing certificate,

14. A method according to claim 13, further comprising configuring the server where the new digital certificate is being installed using a configuration of an existing certificate.

15. A method according to claim 13 where location is determined by scanning the server to determine where the existing certificate is located.

16. A method according to claim 13 where the location of the existing certificate is determined using an installation code.

17. A system for creating a digital certificate comprising:
A CA;
An existing digital certificate;
Means for extracting information from the existing digital certificate; and
A new digital certificate that is created based on the extracted information.
